(19) United States
(12) Patent Application Publication
(10) Pub. No.: US 2025/0271819 A1
(43) Pub. Date: Aug. 28, 2025

(54) TUNING AND DECOUPLING BASED CONTROL BY REFERENCE TRAJECTORY GENERATION

(71) Applicant: Rockwell Automation Technologies, Inc., Mayfield Heights, OH (US)

(72) Inventors: Jan Kolínský, Prague (CZ); Jakub Královec, Zruc-Senec (CZ); Jiri Hanzlík, Prague (CZ); Renata Pytelková, Prague (CZ); Jaroslav Kríž, Ústí nad Labem (CZ); Pavel Jonáš, Prague (CZ); Petr Horácek, Mala Skala (CZ)

(21) Appl. No.: 18/588,544

(22) Filed: Feb. 27, 2024

(51) Int. Cl. G05B 11/36

(52) U.S. Cl. CPC G05B 11/36

(57) ABSTRACT

Embodiments of this present disclosure include a non-transitory computer readable medium storing instructions that, when executed by processing circuitry, cause the processing circuitry to perform operations including determining a predicted value for a process output representative of controlled operation of one or more industrial automation devices within an industrial automation system, receiving an actual value for the process output from the industrial automation devices, and determining a deviation between the predicted value and the actual value for the process output. Additionally, the operations include generating a first portion of a reference trajectory based on a closed-loop response performance to a change in a setpoint, generating a second portion of the reference trajectory based on a calculated effect from a disturbance variable on the actual value for the process output, and generating a third portion of the reference trajectory based on an estimation of an unmeasured disturbance variable.

### BACKGROUND

This disclosure generally relates to systems and methods for tuning and decoupling optimization-based control systems within industrial automation systems. More particularly, embodiments of the present disclosure are directed toward utilizing reference trajectory generation by considering both measured and unmeasured disturbance variables in conjunction with a classical setpoint filter approach.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light and not as admissions of prior art.

Industrial automation systems may include automation control and monitoring systems. The automation control and monitoring systems may monitor statuses and/or receive sensing data from a wide range of devices, such as valves, electric motors, various types of sensors, other suitable monitoring devices, or the like. In addition, one or more components of the automation control and monitoring systems, such as programming terminals, automation controllers, input/output (IO) modules, communication networks, human-machine interface (HMI) terminals, and the like, may use the statuses and/or collected information to provide alerts to operators to change or adjust an operation of one or more components of the industrial automation system (e.g., such as adjusting operation of one or more actuators), to manage the industrial automation system, or the like.

One version of automation control used to manage industrial automation systems is optimization-based control (OBC), an advanced process control technique aimed at control of constrained multi-variable dynamical processes. Standard methods for tuning OBC systems include setting weighting coefficients that seek to minimize variations between process outputs, or controlled variables (CVs), and their setpoints. Some of these standard methods include moving suppression weights to penalize a rate of change of certain manipulated variables (MVs). However, standard tuning methods are not intuitive in the sense of explicit definition of closed loop response or performance of CVs. Existing methods allowing the explicit definition of the closed loop response do not account for disturbance variables (DVs), whether measured or unmeasured. Accordingly, it is now recognized that new solutions are needed for facilitating and improving OBC techniques as they relate to industrial automation systems.

### SUMMARY

A summary of certain embodiments disclosed herein is set forth below. It should be understood that these aspects are presented merely to provide the reader with a brief summary of these certain embodiments and that these aspects are not intended to limit the scope of this present disclosure. Indeed, this present disclosure may encompass a variety of aspects that may not be set forth below.

In one embodiment, a non-transitory computer readable medium storing instructions that, when executed by a processor, cause the processor to perform operations including determining a predicted value for a process output representative of controlled operation of one or more industrial automation devices within an industrial automation system, receiving an actual value for the process output from the industrial automation devices, and determining a deviation between the predicted value and the actual value for the process output. Additionally, the operations include generating a first portion of a reference trajectory based on a closed-loop response performance to a change in a setpoint, generating a second portion of the reference trajectory based on a calculated effect from a disturbance variable on the actual value for the process output, and generating a third portion of the reference trajectory based on an estimation of an unmeasured disturbance variable, such that the unmeasured disturbance variable is based on the determined deviation between the predicted value and the actual value for the process output. Further, the operations include summing the first portion, second portion, and third portion of the reference trajectory, and outputting the reference trajectory to the industrial automation system.

In another embodiment, a system includes processing circuitry and a memory, accessible by the processing circuitry, and storing instructions that, when executed by the processing circuitry, cause the processing circuitry to perform actions including determining a predicted value for a process output representative of controlled operation of one or more industrial automation devices within an industrial automation system, and receiving an actual value of the process output from the industrial automation devices. Additionally, the actions include determining a deviation between the predicted value and the actual value for the process output and generating a portion of a reference trajectory based on an estimation of an unmeasured disturbance variable, such that the unmeasured disturbance variable is based on the determined deviation between the predicted value and the actual value for the process output.

In yet another embodiment, a method includes determining a predicted value for a process output representative of controlled operation of one or more industrial automation devices within an industrial automation system and receiving an actual value for the process output from the industrial automation devices. Additionally, the method includes generating a first portion of a reference trajectory based on a closed-loop response performance to a change in a setpoint, generating a second portion of the reference trajectory based on a calculated effect from a measured disturbance variable on the actual value for the process output, and generating a third portion of the reference trajectory based on an estimation of an unmeasured disturbance variable. Further, the method includes summing the first portion, second portion, and third portion of the reference trajectory and outputting the reference trajectory to the industrial automation system.

### BRIEF DESCRIPTION OF THE DRA WINGS

These and other features, aspects, and advantages of the present disclosure may become better understood when the following detailed description is read with reference to the accompanying drawings in which like characters represent like parts throughout the drawings, wherein:

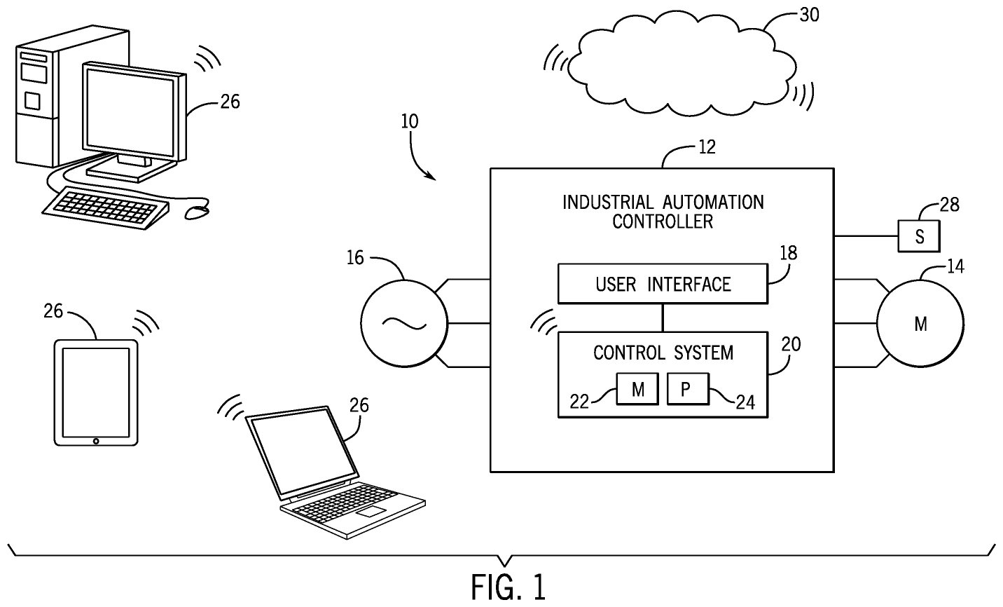

FIG. 1 is a schematic view of an embodiment of an operation technology (OT) environment, in accordance with aspects of the present disclosure;

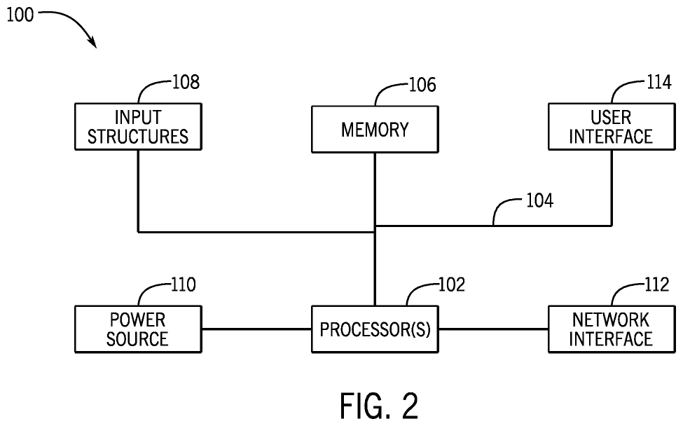

FIG. 2 is a block diagram of example components that could be used in the industrial automation system of FIG. 1, in accordance with aspects of the present disclosure;

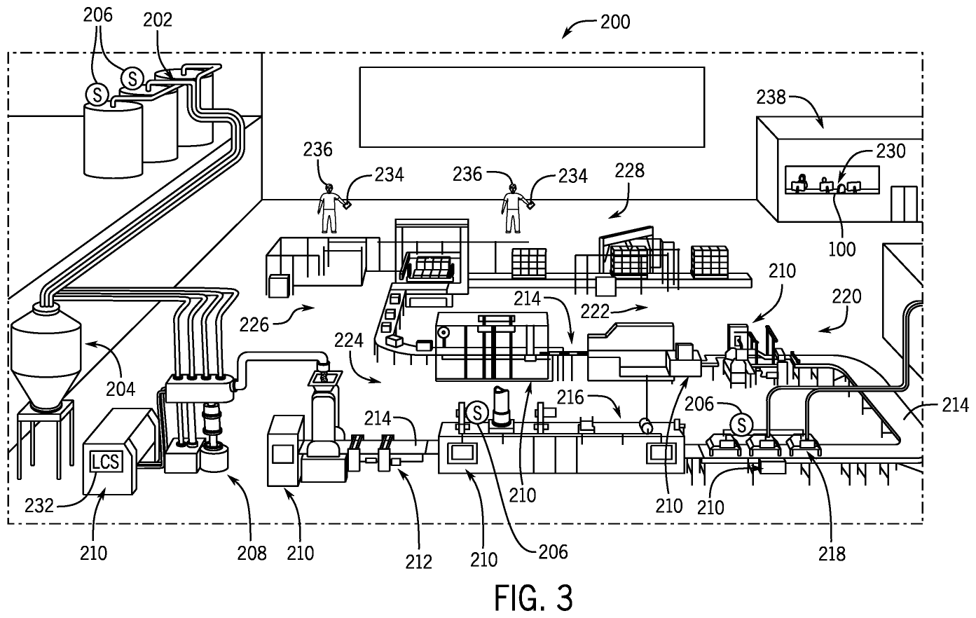

FIG. 3 is a perspective view of an embodiment of an industrial automation system employing an embodiment of an OT environment from FIG. 1, in accordance with aspects of the present disclosure;

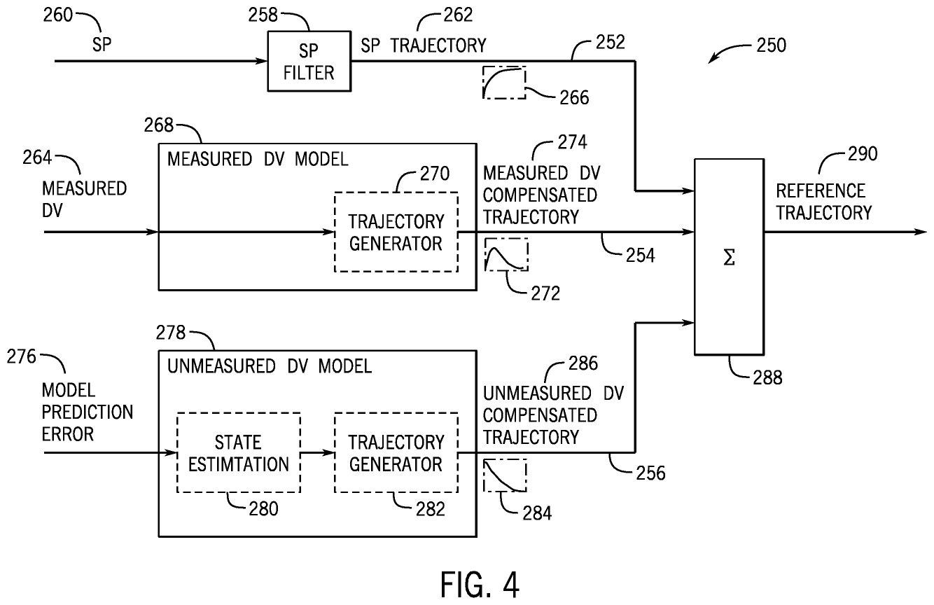

FIG. 4 is a block diagram of an embodiment of a reference trajectory generator that may be used for optimization-based control (OBC) within the industrial automation system of FIG. 3, in accordance with aspects of the present disclosure;

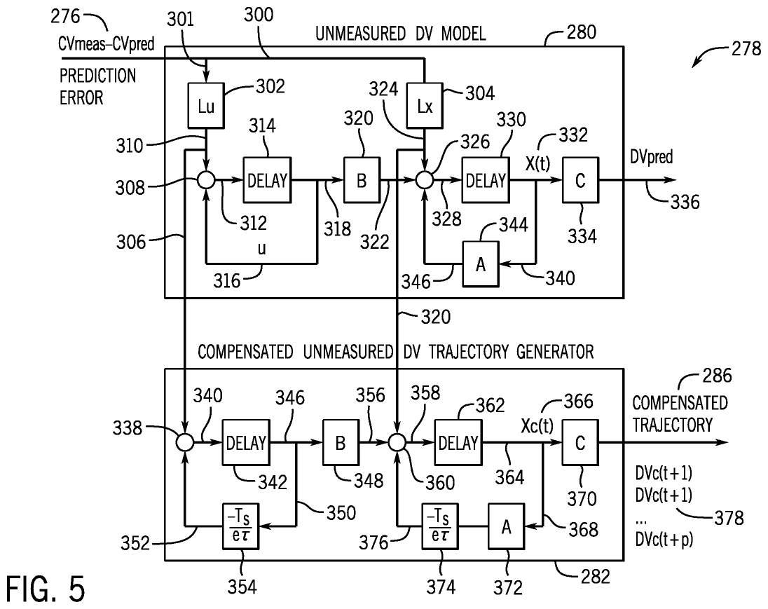

FIG. 5 is a block diagram for determining a compensated trajectory from an unmeasured disturbance variable (DV) model, in accordance with aspects of the present disclosure;

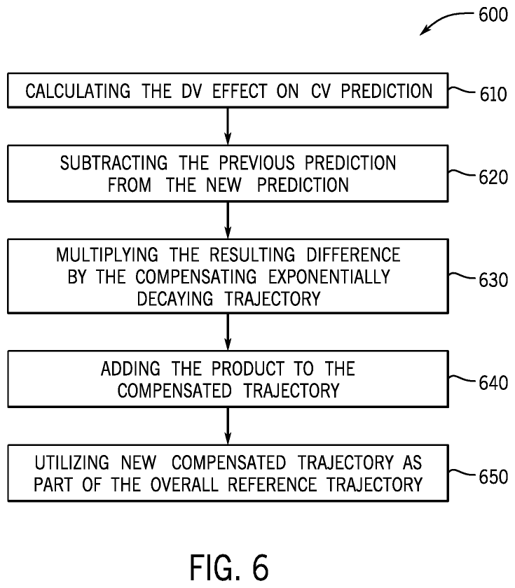

FIG. 6 is a flowchart of a process for determining a compensation value for the effects from measured DVs, in accordance with aspects of the present disclosure;

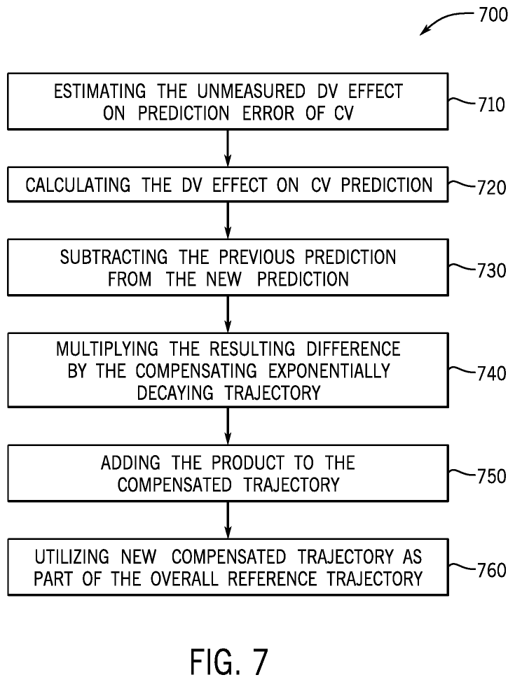

FIG. 7 is a flowchart of a process for determining a compensation value for the effects from unmeasured DVs, in accordance with aspects from the present disclosure;

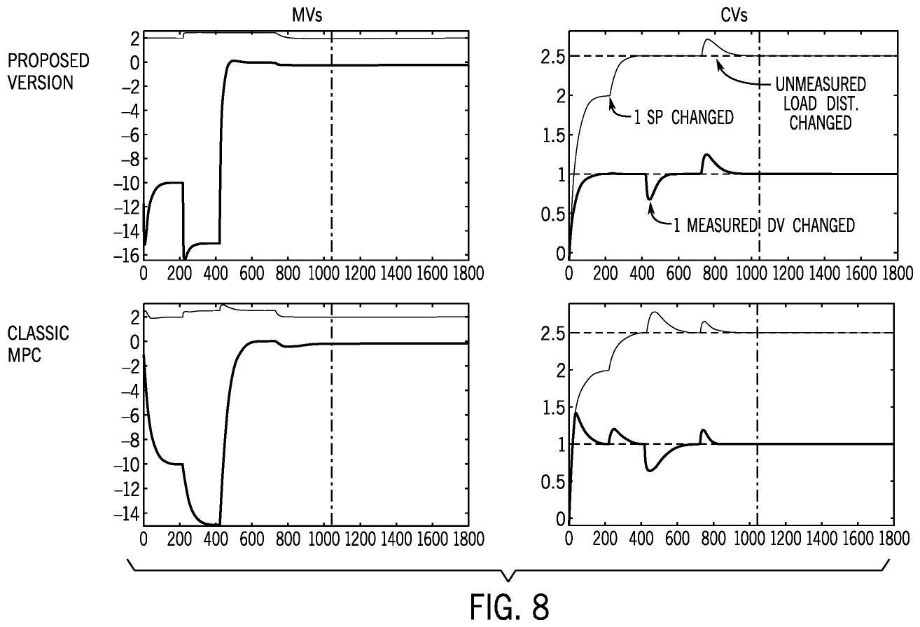

FIG. 8 is a series of graphs illustrating an example of a system response in a self-regulating process with no model error, in accordance with aspects from the present disclosure;

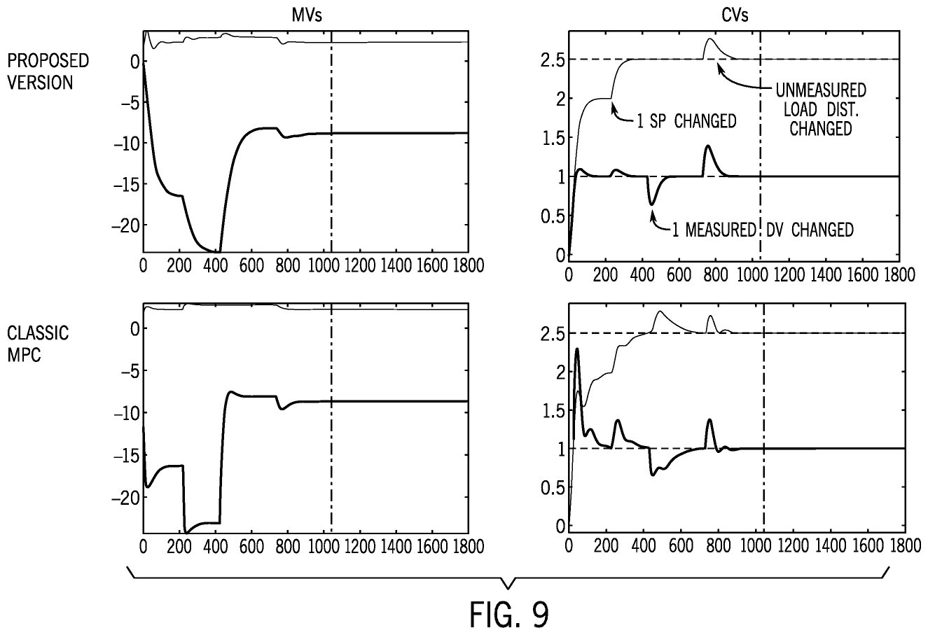

FIG. 9 is a series of graphs illustrating an example of a system response in a self-regulating process with model gain and dead time error, in accordance with aspects from the present disclosure;

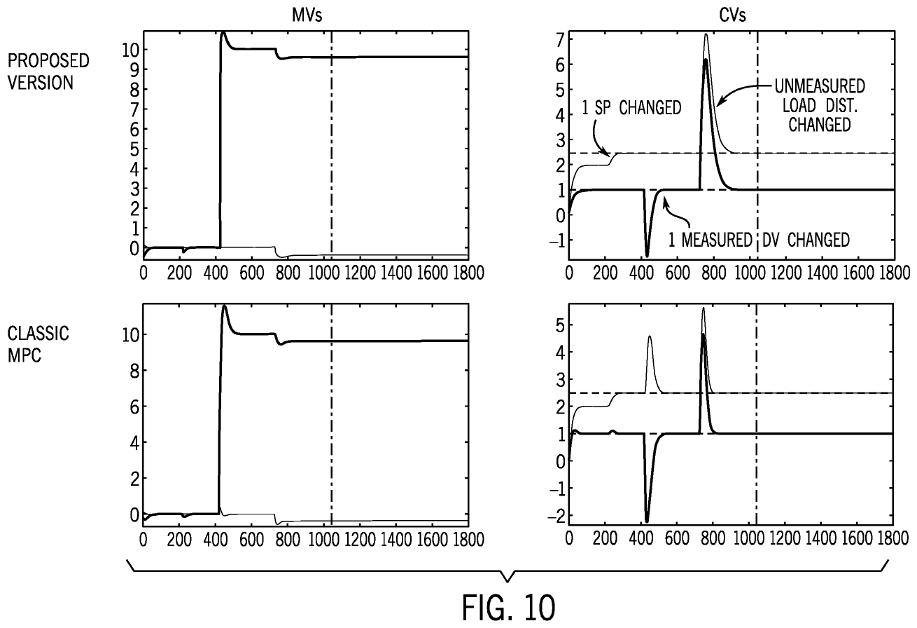

FIG. 10 is a series of graphs illustrating an example of a system response in an integrating process with no model error, in accordance with aspects from the present disclosure; and

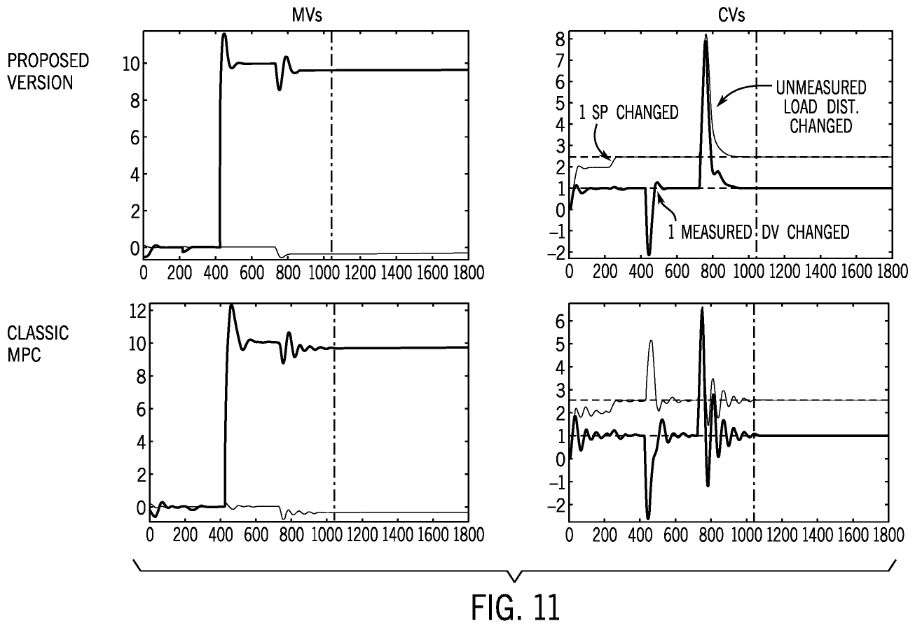

FIG. 11 is a series of graphs illustrating an example of a system response in an integrating process with model gain and dead time error, in accordance with aspects from the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Standard methods for tuning and decoupling of optimization-based control (OBC) set weighting coefficients to handle variations between process outputs, or controlled variables (CVs) and their respective setpoints, and move suppression weights that penalize rate of change of manipulated variables (MVs). A more intuitive method of tuning is based on an explicit specification of a desired closed loop response of CV in terms of response time constant, or settling time. Classical methods handle the tuning of setpoint tracking by using a setpoint filter with desired dynamics according to specified closed loop response but do not account for both measured and unmeasured disturbances.

Present embodiments of the disclosure are generally directed towards systems and methods for tuning and decoupling optimization-based control systems that are utilized within an operation technology (OT) environment. For example, present embodiments provide a control software configured to determine a predicted value for a process output representative of controlled operation of industrial automation devices within an industrial automation system, and compare the predicted value with an actual received value for the process output. Additionally or alternatively, present embodiments include generating a reference trajectory configured to provide a control signal to accommodate for differences between the predicted and received values for the process outputs.

Included in the reference trajectory is a first portion of the reference trajectory that is generated based on a closed-loop response performance to a change in a setpoint. In other embodiments, the first portion of the reference trajectory includes applying a first order setpoint filter configured to tune the process outputs to correspond to a setpoint. Additionally or alternatively, a second portion of the reference trajectory is generated based on a calculated effect from a disturbance variable (DV) on the received value for the process output. For example, the second portion includes applying a measured DV model configured to output a measured DV compensated trajectory. In some embodiments, the measured DV model includes a finite step response model.

Additionally or alternatively, present embodiments may include a third portion of the reference trajectory that is generated base on an estimation of an unmeasured disturbance variable, such that the unmeasured disturbance variable is based on the determined deviation between the predicted value and the actual received value for the process output. For example, the third portion includes applying an unmeasured DV model configured to output an unmeasured DV compensated trajectory. In other embodiments, the unmeasured DV model includes a linear state space model with unknown inputs, while in some embodiments, the unmeasured DV model includes a state estimation block and/or a trajectory generator. The state estimation block may be configured to receive an input indicative of a determined deviation between the predicted value and the actual value for the process output, and output an estimation for a value for the determined deviation that is attributable to the unmeasured disturbance variable. In other embodiments, the state estimation block may include at least one observer gain vector and include at least one delay block. The trajectory generator may be configured to receive the output from the state estimation block, and then output a compensated trajectory. In other embodiments, the trajectory generator includes at least one delay block configured to account for a dead time between a change in system input and the system response, and at least one summing node configured to receive input signal paths and transmit output signal paths.

Further, present embodiments provide for systems and methods for generating the second and third portions of the reference trajectory. For example, methods for generating the second portion of the reference trajectory include calculating an effect that the measured disturbance variable has on the predicted value for the process output, subtracting the predicted value for the process output from a new predicted value to obtain a difference, and then multiplying the difference by a compensated trajectory to obtain a product. Additionally or alternatively, the method includes summing the product with the compensated trajectory to obtain a sum, and utilizing the sum as an updated compensated trajectory as part of the refence trajectory. In other embodiments, methods for generating the third portion of the reference trajectory include estimating a value of the unmeasured disturbance variable based on a determined difference between the received actual value and the predicted value for the process output, calculating an effect that the unmeasured disturbance variable had on the process output, and subtracting the predicted value for the process output from a new predicted value to obtain a difference. Additionally or alternatively, the method may include multiplying the difference by a compensated trajectory to obtain a product, summing the product with the compensated trajectory to obtain a sum, and then utilizing the sum as an updated compensated trajectory as a part of the reference trajectory. Present embodiments also provide for summing the first, second, and third portions of the reference trajectory and outputting the reference trajectory to the industrial automation system.

With the foregoing in mind, FIG. 1 is a schematic view of an example OT environment 10 in which the embodiments described herein may be implemented. As shown, the OT environment 10 is an industrial automation system that includes a controller 12 and an actuator 14 (e.g., a motor). The OT environment 10 may also include, or be coupled to, a power source 16. The power source 16 may include a generator, an external power grid, a battery, or some other source of power. The controller 12 may be a stand-alone control unit that controls multiple industrial automation components (e.g., a plurality of motors 14), a controller 12 that controls the operation of a single automation component (e.g., motor 14), or a subcomponent within a larger OT environment 10. In the instant embodiment, the controller 12 includes a user interface 18, such as a human machine interface (HMI), and a control system 20, which may include a memory 22 and a processor 24. The controller 12 may include a cabinet or some other enclosure for housing various components of the OT environment 10, such as a motor starter, a disconnect switch, etc.

The control system 20 may be programmed (e.g., via computer readable code or instructions stored on the memory 22, such as a non-transitory computer readable medium, and executable by the processor 24) to provide signals for controlling the motor 14. In certain embodiments, the control system 20 may be programmed according to a specific configuration desired for a particular application. For example, the control system 20 may be programmed to respond to external inputs, such as reference signals, alarms, command/status signals, etc. The external inputs may originate from one or more relays or other electronic devices. The programming of the control system 20 may be accomplished through software or firmware code that may be loaded onto the internal memory 22 of the control system 20 (e.g., via a locally or remotely located computing device 26) or programmed via the user interface 18 of the controller 12. The control system 20 may respond to a set of operating parameters. The settings of the various operating parameters may determine the operating characteristics of the controller 12. For example, various operating parameters may determine the speed or torque of the motor 14 or may determine how the controller 12 responds to the various external inputs. As such, the operating parameters may be used to map control variables within the controller 12 or to control other devices communicatively coupled to the controller 12. These variables may include, for example, speed presets, feedback types and values, computational gains and variables, algorithm adjustments, status and feedback variables, programmable logic controller (PLC) control programming, and the like.

In some embodiments, the controller 12 may be communicatively coupled to one or more sensors 28 for detecting operating temperatures, voltages, currents, pressures, flow rates, and other measurable variables associated with the OT environment 10. With feedback data from the sensors 28, the control system 20 may keep detailed track of the various conditions under which the OT environment 10 may be operating. For example, the feedback data may include conditions such as actual motor speed, voltage, frequency, power quality, alarm conditions, etc. In some embodiments, the feedback data may be communicated back to one or more computing devices 26 for additional analysis.

The computing device 26 may be communicatively coupled to the controller 12 via a wired or wireless connection. The computing device 26 may receive inputs from a user defining an industrial automation project using a native application running on the computing device 26 or using a website accessible via a browser application, a software application, or the like. The user may define the industrial automation project by writing code, interacting with a visual programming interface, inputting or selecting values via a graphical user interface, or providing some other inputs. The user may use licensed software and/or subscription services to create, analyze, and otherwise develop the project. The computing device 26 may send a project to the controller 12 for execution. Execution of the industrial automation project causes the controller 12 to control components (e.g., motor 14) within the OT environment 10 through performance of one or more tasks and/or processes. In some applications, the controller 12 may be communicatively positioned in a private network and/or behind a firewall, such that the controller 12 does not have communication access outside a local network and is not in communication with any devices outside the firewall, other than the computing device 26. The controller 12 may collect feedback data during execution of the project, and the feedback data may be provided back to the computing device 26 for analysis. Feedback data may include, for example, one or more execution times, one or more alerts, one or more error messages, one or more alarm conditions, one or more temperatures, one or more pressures, one or more flow rates, one or more motor speeds, one or more voltages, one or more frequencies, and so forth. The project may be updated via the computing device 26 based on the analysis of the feedback data.

The computing device 26 may be communicatively coupled to a cloud server 30 or remote server via the internet, or some other network. In one embodiment, the cloud server 30 may be operated by the manufacturer of the controller 12, a software provider, a seller of the controller 12, a service provider, operator of the controller 12, owner of the controller 12, etc. The cloud server 30 may be used to help customers create and/or modify projects, to help troubleshoot any problems that may arise with the controller 12, develop policies, or to provide other services (e.g., project analysis, enabling, restricting capabilities of the controller 12, data analysis, controller firmware updates, etc.). The remote/cloud server 30 may be one or more servers operated by the manufacturer, software provider, seller, service provider, operator, or owner of the controller 12. The remote/cloud server 30 may be disposed at a facility owned and/or operated by the manufacturer, software provider, seller, service provider, operator, or owner of the controller 12. In other embodiments, the remote/cloud server 30 may be disposed in a datacenter in which the manufacturer, software provider, seller, service provider, operator, or owner of the controller 12 owns or rents server space. In further embodiments, the remote/cloud server 30 may include multiple servers operating in one or more data center to provide a cloud computing environment.

FIG. 2 illustrates a block diagram of example components of a computing device 100 that could be used as the computing device 26, the cloud/remote server 30, the controller 12, or some other device provided by the present disclosure. As used herein, the computing device 100 may be implemented as one or more computing systems, including a laptop, notebook, desktop, tablet, HMI, or workstation computer, as well as server type devices (e.g., on-prem servers, remote servers, cloud servers) or portable, communication type devices, such as cellular telephones and/or other suitable computing devices.

As illustrated, the computing device 100 may include various hardware components, such as one or more processors 102, one or more busses 104, memory 106, input structures 108, a power source 110, a network interface 112, a user interface 114, and/or other computer components useful in performing the functions described herein. The one or more processors 102 may include, in certain implementations, microprocessors configured to execute instructions stored in the memory 106 or other accessible locations. Alternatively, the one or more processors 102 may be implemented as application-specific integrated circuits (ASICs), field-programmable gate arrays (FPGAs), and/or other devices designed to perform functions discussed herein in a dedicated manner. As will be appreciated, multiple processors 102 or processing components may be used to perform functions discussed herein in a distributed or parallel manner.

The memory 106 may encompass any tangible, non-transitory medium for storing data or executable routines. Although shown for convenience as a single block in FIG. 2, the memory 106 may encompass various discrete media in the same or different physical locations. The one or more processors 102 may access data in the memory 106 via one or more busses 104.

The input structures 108 may allow a user to input data and/or commands to the device 100 and may include mice, touchpads, touchscreens, keyboards, controllers, and so forth. The power source 110 can be any suitable source for providing power to the various components of the computing device 100, including line and battery power. In the depicted example, the device 100 includes a network interface 112. Such a network interface 112 may allow communication with other devices on a network using one or more communication protocols. In the depicted example, the device 100 includes a user interface 114, such as a display that may display images or data provided by the one or more processors 102. The user interface 114 may include, for example, a monitor, a display, and so forth. As will be appreciated, in a real-world context a processor-based system, such as the computing device 100 of FIG. 2, may be employed to implement some or all of the present approach, such as performing the functions of the controller, the computing device 26, and/or the cloud/remote server 30 shown in FIG. 1, as well as other memory-containing devices.

FIG. 3 is a perspective view of an example industrial automation system 200 employed by a food manufacturer. It should be noted that although the example industrial automation system 200 of FIG. 3 is directed at a food manufacturer, the present embodiments described herein may be employed within any suitable industry, such as automotive, cosmetics, chemical manufacturing/processing, mining, hydrocarbon production, manufacturing, and the like. The following brief description of the example industrial automation system 200 employed by the food manufacturer is provided herein to help facilitate a more comprehensive understanding of the OT environment to which the techniques described herein may be applied. As such, the embodiments described herein should not be limited to be applied to the example depicted in FIG. 3.

Referring now to FIG. 3, the example industrial automation system 200 for a food manufacturer may include any number of machines, such as silos 202 and tanks 204. The silos 202 and the tanks 204 may store different types of raw material, such as grains, salt, yeast, sweeteners, flavoring agents, coloring agents, vitamins, minerals, and preservatives. In some embodiments, sensors 206 may be positioned within or around the silos 202, the tanks 204, or other suitable locations within the industrial automation system 200 to measure certain properties, such as temperature, mass, volume, pressure humidity, and the like.

The raw materials may be provided to a mixer 208, which may mix the raw materials together according to a specified ratio. The mixer 208 and other machines in the industrial automation system 200 may employ certain industrial automation devices 210 to control the operations of the mixer 208 and other machines. The industrial automation devices 210 may include controllers (e.g., industrial automation controller 12), input/output (I/O) modules, motor control centers (e.g., control system 20), motors (e.g., actuator 14), human-machine interfaces (e.g., user interface 18), operator interfaces, contactors, starters, sensors (e.g., sensor 28, sensors 206), conveyors, drives, relays, protection devices, switchgear, compressors, firewall, network switches (e.g., Ethernet switches, modular-managed, fixed-managed, service-router, industrial, unmanaged, etc.) and the like.

The mixer 208 may provide a mixed compound to a depositor 212, which may deposit a certain amount of the mixed compound onto conveyor 214. The depositor 212 may deposit the mixed compound on the conveyor 214 according to a shape and amount that may be specified to a control system for the depositor 212. The conveyor 214 may be any suitable conveyor system that transports items to various types of machinery across the industrial automation system 200. For example, the conveyor 214 may transport deposited material from the depositor 212 to an oven 216, which may bake the deposited material. The baked material may be transported to a cooling tunnel 218 to cool the baked material, such that the cooled material may be transported to a tray loader 220 via the conveyor 214. The tray loader 220 may include machinery that receives a certain amount of the cooled material for packaging. By way of example, the tray loader 220 may receive 25 ounces of the cooled material, which may correspond to an amount of cereal provided in a cereal box.

A tray wrapper 222 may receive a collected amount of cooled material from the tray loader 220 into a bag, which may be sealed. The tray wrapper 222 may receive the collected amount of cooled material in a bag and seal the bag using appropriate machinery. The conveyor 214 may transport the bagged material to case packer 224, which may package the bagged material into a box. The boxes may be transported to a palletizer 226, which may stack a certain number of boxes on a pallet that may be lifted using a forklift or the like. The stacked boxes may then be transported to a shrink wrapper 228, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 200, the industrial automation devices 210 may be used to provide power to the machinery used to perform certain tasks, provide protection to the machinery from electrical surges, prevent injuries from occurring with human operators in the industrial automation system 200, monitor the operations of the respective device, communicate data regarding the respective device to a supervisory control system 230, and the like. In some embodiments, each industrial automation device 210 or a group of industrial automation devices 210 may be controlled using a local control system 232. The local control system 232 may receive data regarding the operation of the respective industrial automation device 210, other industrial automation devices 210, user inputs, and other suitable inputs to control the operations of the respective industrial automation devices 210.

An operator device 234 is an example of the computing device 26 that enables an operator 236 to access or interface with other industrial automation devices 210 and/or computing devices. For example, the operator device 234 may include the processor 102, busses 104, memory 106, input structures 108, power source 110, network interface 112, and user interface 114.

Collectively, any or all of the machines (e.g., mixer 208, palletizer 226), the industrial automation devices 210, the computing devices 26, the cloud server 30, the supervisory control system 230, and any other elements of FIG. 3 may constitute the OT environment. These elements may communicate across the OT environment via a network (e.g., a local area network (LAN)). In some embodiments, the network may be managed from a network operations center 238 (NOC). The NOC 238 is a centralized location from which a network administrator may monitor and manage the network. For example, the NOC 238 may include a central computing system which executes a network security system, monitors traffic into and out of the network, maintains databases, and manages security policies. As shown, the NOC 238 is local to the industrial automation system 200, but in other embodiments, the NOC 238 may be located at a remote location.

In regards to FIGS. 1-3, the present disclosure is generally directed towards systems and methods for tuning and decoupling optimization-based control systems that are utilized within the OT environment. Optimization-based control (OBC) is an advanced process control technique aimed at controlling constrained multivariable dynamical processes. OBC is an established and popular technology in many industrial settings and OT environments for its capability to systematically handle the above-mentioned constrained multivariable dynamical processes, while simultaneously reducing operating costs. To achieve these goals, traditional methods of OBC combine the use of an internal dynamic model of the process with a cost function, and then utilize an optimization algorithm configured to minimize the cost function and manipulate process inputs to meet specified constraints. In so doing, OBC reduces variances and enables a process to run at more profitable operating points, thereby improving the performance and reducing operating costs.

Generally speaking, a control process includes one or more process inputs and one or more process outputs. The process inputs may be divided into at least two groups-manipulated variables (MVs), which are variables that a controller is configured to adjust, and disturbance variables (DVs), which are variables that the controller is not configured to adjust. Process outputs may be referred to as controlled variables, or CVs. Traditional methods for implementing an OBC include tuning and refining the control process by introducing weighting coefficients that enables the controller to account for actual and predicted deviations of MVs and CVs from their respective setpoints and output values. Traditional embodiments of an OBC enable the controller to move suppression weights to penalize a rate of change of MVs. By adding these weighting coefficients, a user may adjust and select a determined trade-off between the performance (i.e. aggressiveness) and the robustness of the controller.

Additionally, a well-known method for balancing the trade-off between performance and robustness of the controller is with the use of a setpoint filter. When a setpoint is modified, the setpoint filter enables the controller to achieve this system modification by using a closed loop control response to gradually enact the change. In other words, the setpoint filter enables the control system to provide a smooth, controlled, transition from the previous state to the new setpoint, and minimize undesired overshoots and oscillations between the control system response and the new setpoint. By metering out the response in smaller increments, the setpoint filter may provide a control system with the capability to provide a rapid response while still limiting excessive variability.

As discussed above, disturbance variables (DVs) are the variables that the controller is not configured to adjust. These DVs may be divided into two subgroups-measured DVs and unmeasured DVs. A measured DV is an independent input that affects the CV and is directly received by the controller. Detecting and accounting for measured DVs by the controller before they have an opportunity to affect a CV is referred to as feedforward control. On the other hand, unmeasured DVs represent unknown variables that upset plant operation and production. This DV can be attributed to errors in a model, unmodeled dynamics, or factors that are unforeseen and cannot be accounted for preemptively. The controller accounts for unmeasured DVs by tuning the control in a process known as feedback compensation. Methods for improved tuning control techniques that utilize aspects of feedforward and feedback control are desired.

FIG. 4 illustrates a schematic view of an embodiment of a reference trajectory generator 250 that may be used for OBC in accordance with aspects of the present disclosure. In the illustrated embodiment, the reference trajectory generator 250 includes a first portion (top branch 252), a second portion (middle branch 254), and a third portion (bottom branch 256), each performing a role in the overall function of the OBC. The first portion, represented by the top branch 252 in FIG. 4, corresponds to the portion of the OBC that initiates and implements a compensation control signal in response to a change in a setpoint 260 in the system. The top branch 252 of the reference trajectory generator 250 may include a setpoint filter 258 that receives the setpoint 260 as an input to the overall system. Based on the value of the setpoint 260, the setpoint filter 258 may output a setpoint trajectory 262 that is configured to tune the system to bring the CVs of the system to correspond with the setpoint 260. In the illustrated embodiment, the setpoint filter 258 is a first order filter with a specified time constant, but it is envisioned that the setpoint filter 258 may generally be of any order. A desired closed loop response performance can be specified, for example, by a time constant or settling time that defines the first order setpoint filter. The setpoint trajectory 262 that is generated as an output from the setpoint filter 258 results in at least a part of the feedforward control part of the OBC. In a non-limiting embodiment, a graphical representation 266 of the setpoint trajectory 262 is shown on the top branch 252 of the reference trajectory generator 250. The graphical representation 266 illustrates an embodiment of the setpoint trajectory 262 generated in response to an increase in the setpoint 260 input.

When the OBC process includes dead time (i.e. a delay from when a MV changes until when a CV first begins to respond), the trajectory 262 from the setpoint filter 258 may be delayed. For example, the controller would be able to account for a change in the setpoint at a future time that is equal to a current time added to the aforementioned dead time. For this reason, the dead time is added to the setpoint filter 258. In some embodiments, multiple MVs that affect the CVs may have different dead times, such that the system selects a single dead time for the filter. Additionally or alternatively, the smallest of the dead times from relevant MV-CV models may be selected. In other embodiments, an effective dead time may be calculated by using a weighted average of dead times for all MV-CV models relevant to a particular CV. In calculating the weighted average, the dead times are given weights corresponding to the associated gains of the corresponding models.

The second portion of the reference trajectory generator 250 is represented by the middle branch 254 in FIG. 4. The middle branch 254 corresponds to the portion of the OBC that provides system compensation for a measured DV 264. In the illustrated embodiment, a measured DV model block 268 provides a calculation for a DV effect on a CV prediction. Generally, the function of the DV model (block 268) is to utilize a measured DV model trajectory generator 270 to generate a measured DV compensated trajectory 274 based on the specified closed loop response performance or dynamics. In a non-limiting embodiment, a graphical representation of the measured DV compensated trajectory 274 illustrates a measured DV compensated trajectory 274 generated in response to an introduction of the measured DV 264, and then the corresponding system response. The measured DV compensated trajectory 274 that is generated as an output from the measured DV model 268 results in at least a part of the feedforward control part of the OBC. The compensated dynamics may be explicitly described using standard means (e.g. a transfer function, an exponential decay function, a state space function, a step function, an impulse function, etc.).

In a non-limiting embodiment, the measured DV model 268 may be represented by a finite step response model. For a given prediction horizon, the measured DV model 268 may be represented by the following equations:

$$y ( t ) = {\sum }_{i = 1}^{p} {b}_{i} Δ u ( t - i ) , Δ u ( t ) = u ( t ) - u ( t - 1 ) \qquad ( 1 )$$

In a non-limiting embodiment, in equation (1) above, the bi coefficients may be found as a result of a step response of a linear or nonlinear system. Predicted values may be calculated as shown below:

$$y ( t + k ) = {\sum }_{i = k}^{p} {b}_{i} Δ u ( t + k - i ) \qquad ( 2 )$$

The compensated response with exponential decay may be calculated as shown below:

$${y}_{c} ( t + k ) = {\sum }_{i = k}^{p} {e}^{\frac{- i {T}_{s}}{τ}} {b}_{i} Δ u ( t + k - i ) \qquad ( 3 )$$

In a non-limiting embodiment, a measured DV compensation model that generates a compensated trajectory of DV is shown below, where Tₛ is the sampling period.

$$\begin{matrix}{y}_{c} ( t + k ) = {\sum }_{i = k}^{p} {d}_{i} Δ u ( t + k - i ) , & {d}_{i} = {b}_{i} {e}^{\frac{- i {T}_{s}}{τ}}\end{matrix} \qquad ( 4 )$$

In other embodiments, the measured DV model 268 may be represented by a linear state space model as shown below:

$$x ( t + 1 ) = A x ( t ) + B u ( t ) \qquad ( 5 )$$

$$y ( t ) = C x ( t ) \qquad ( 6 )$$

In a non-limiting embodiment, the measured DV model 268 that generates the measured DV compensated trajectory 274 may be defined by the following equations. The measured DV model 268 may be fed by changes of a measured DV 264.

$${u}_{c} ( t + 1 ) = {e}^{\frac{- {τ}_{s}}{τ}} {u}_{c} ( t ) + Δ u ( t + 1 ) \qquad ( 7 )$$

$${x}_{c} ( t + 1 ) = {e}^{\frac{- {T}_{S}}{τ}} A {x}_{c} ( t ) + B {u}_{c} ( t ) \qquad ( 8 )$$

$${y}_{c} ( t ) = C {x}_{c} ( t ) \qquad ( 9 )$$

The measured DV model 268 generates a compensated trajectory 274 of the measured DV by calculating y_{c}(t+k) using the recursive equations (7)-(9) above. In certain embodiments where a future measured DV trajectory is not known, then it may be assumed that Δu(t+k)=0.

In a non-limiting embodiment, the measured DV model 268 may be represented by a nonlinear state space model. For a given prediction horizon, the measured DV model 268 may be represented by the following equations:

$$x ( t + 1 ) = f ( x ( t ) , u ( t ) ) \qquad ( 10 )$$

$$y ( t ) = g ( x ( t ) ) \qquad ( 11 )$$

Assuming that based on u(t−1) and x(t−1) a measured DV compensated trajectory 274 has been generated at time (t−1) as a sequence as shown below:

$$\{ {y}_{c} ( t - 1 ) , {y}_{c} ( t ) , … , {y}_{c} ( t + p - 1 ) \vert x ( t - 1 ) , u ( t - 1 ) \} \qquad ( 12 )$$

In some embodiments, a measured DV compensated trajectory 274 may be generated so that based on a previous model state and input, the predicted model output is calculated for (p+1) steps using forward simulation.

$$\{ y ( t - 1 ) , y ( t ) , … , y ( t + p ) \vert x ( t - 1 ) , u ( t - 1 ) \} \qquad ( 13 )$$

Additionally or alternatively, based on a new input u(t), new predictions may be calculated.

$$\{ y ( t ) , y ( t + 1 ) , … , y ( t + p + 1 ) \vert x ( t ) , u ( t ) \} \qquad ( 14 )$$

Additionally or alternatively, a change trajectory dy(t) may be calculated as a difference between equations (13) and (14).

$$d y ( t + k ) = \{ y ( t + k ) \vert x ( t - 1 ) , u ( t - 1 ) \} - \{ y ( t + k ) \vert x ( t ) , u ( t ) \} , k = 0 .. p \qquad ( 15 )$$

In a non-limiting embodiment, a change in the measured DV compensated trajectory dy_{c}(t) may be defined by the following equation:

$$d {y}_{c} ( t + k ) = {e}^{\frac{- κ {τ}_{s}}{τ}} d y ( t + k ) \qquad ( 16 )$$

A value of p may be selected such that dy_{c}(t+p) is a small number, so that

$$d {y}_{c} ( t + p + i ) = 0 , for i > 0 \qquad ( 17 )$$

As a result, the new compensated trajectory may be a sum of the trajectory ye from previous step and the change of compensated trajectory dy_{c}:

$$\{ {y}_{c} ( t ) , {y}_{c} ( t + 1 ) , … , {y}_{c} ( t + p ) \vert x ( t ) , u ( t ) \} = \{ {y}_{c} ( t ) , … , {y}_{c} ( t + p - 1 ) , 0 \vert x ( t - 1 ) , u ( t - 1 ) \} + \{ d {y}_{c} ( t ) , d {y}_{c} ( t + 1 ) , … , {dy}_{c} ( t + p + 1 ) \vert x ( t ) , u ( t ) \} \qquad ( 18 )$$

When the OBC process includes dead time (i.e. a delay from when a MV changes until when a CV first begins to respond), the measured DV compensated trajectory 274 from the measured DV model 268 may be delayed. In some embodiments, the controller may not be configured to compensate for a measured DV effect that occurs on the prediction horizon prior to the dead time. In certain embodiments, the measured DV compensated trajectory 274 with exponential decay is delayed using a selected time delay T_{d}=d*Tₛ. For example, the finite step response model for the measured DV compensated trajectory 274 taking into account dead time is shown below:

$${y}_{c} ( t + k ) = {\sum }_{i = k}^{p} {e}^{\frac{- ( i - d ) T s}{τ}} {b}_{i} Δ u ( t + k - i ) , k > d \qquad ( 19 )$$

The third portion of the reference trajectory generator 250 is represented by the bottom branch 256 in FIG. 4. The bottom branch 256 corresponds to the portion of the OBC that provides system compensation for unmeasured DVs 276 (e.g. model prediction errors, etc.). In the illustrated embodiment, an unmeasured DV model 278 generates a compensated unmeasured DV trajectory 286 (e.g. unmeasured DV effect on CV prediction) based on specified closed loop performance and/or dynamics. In a non-limiting embodiment, a graphical representation of the unmeasured DV compensated trajectory 284 illustrates an unmeasured DV compensated trajectory 286 generated in response to a prediction of differences of measured and predicted CVs, and then the corresponding system response. The unmeasured DV compensated trajectory 286 that is generated as an output from the unmeasured DV model block 278 results in at least a part of the feedback control part of the OBC. The compensated dynamics may be explicitly described using standard means (e.g. a transfer function, an exponential decay function, a state space function, a step function, an impulse function, etc.).

In a non-limiting embodiment, the unmeasured DV model 278 may be represented by a linear state space model with unknown inputs. The states and the unknown inputs may be estimated by a state observer. The state observer may be designed by a standard pole placement method, standard Kalman filter design techniques, or a moving horizon estimation method. The linear state space model may be represented by the equations below:

$$u ( t + 1 ) = u ( t ) + {L}_{u} e ( t ) \qquad ( 20 )$$

$$x ( t + 1 ) = A x ( t ) + {L}_{x} e ( t ) + B u ( t ) \qquad ( 21 )$$

$$y ( t ) = C x ( t ) \qquad ( 22 )$$

In equations (20) and (21), L^{u} and Lₓ are designed observer gain vectors, and e(t) is an expression representing prediction error. As shown below, e(t) is further defined as:

$$e ( t ) = C {V}_{m e a s} ( t ) - C {V}_{p r e d} ( t ) \qquad ( 23 )$$

In equation (23), the expression CVₘₑᵤₛ(t) is the measured value of the process output, or the CV, and CV_{pred}(t) is the predicted value for the CV from the model.

In an embodiment, the unmeasured DV model 278 that generates the unmeasured DV compensated trajectory 286 may be represented by a series of equations as follows:

$${u}_{c} ( t + 1 ) = {e}^{\frac{- {τ}_{s}}{τ}} {u}_{c} ( t ) + {L}_{u} e ( t ) \qquad ( 24 )$$

$${x}_{c} ( t + 1 ) = {e}^{\frac{- {τ}_{s}}{τ}} A {x}_{c} ( t ) + {L}_{x} e ( t ) + B {u}_{c} ( t ) \qquad ( 25 )$$

$${y}_{c} ( t ) = C {x}_{c} ( t ) \qquad ( 26 )$$

Taking the equations as a whole, the unmeasured DV model 278 generates an unmeasured DV compensated trajectory 286 by calculating y_{c}(t+k) using the above recursive equations.

In a non-limiting embodiment, the reference trajectory generator 250 includes a summation calculation block 288. The summation calculation block is configured to take the calculated setpoint trajectory 262 from the top branch 252, the measured DV compensated trajectory 274 from the middle branch 254, and the unmeasured DV compensated trajectory 286 from the bottom branch 256, and add the trajectories together. In certain embodiments, the resulting sum is a reference trajectory 290 that may be utilized by OBC processes in order to fine tune and better control multivariable dynamical processes. In some embodiments, the trajectories 262, 274, 286 may be given equal weights, whereas in other embodiments, the trajectories 262, 274, 286 may be given different weights such that a particular one of the trajectories 262, 274, 286 contributes to the reference trajectory more than one or both of the other trajectories 262, 274, 286.

Turning to FIG. 5, a schematic view of an embodiment of the unmeasured DV model 278 is illustrated according to aspects of the present disclosure. In the illustrated embodiment, the unmeasured DV model 278 includes at least two separate calculation process blocks—the state estimation block 280 and the trajectory generator 282. The state estimation block 280 is configured to receive an input indicative of a prediction for the difference between a predicted CV value and a measured CV value, and provide an estimation for a value for this difference due to disturbance variables to the trajectory generator 282. The trajectory generator 282 is configured to receive an output from the state estimation block 280 and output a compensated trajectory 286 that may be used in conjunction with trajectories output from the feedforward control components.

In a non-limiting embodiment, the prediction error 276 is received as an input to the state estimation block 280 along an input path 300, 301, and is split between two observer gain vectors, Lᵤ 302 and Lₓ 304. The Lᵤ 302 gain vector is configured to take a path 301 from the prediction error 276 and output a path 310 to a first summing node 308. In some embodiments, the output path 310 may have an additional path 306 that leads to a third summing node 338 disposed in the trajectory generator 282. From the first summing node 308, the node outputs a signal path 312 that includes a first delay block 314. In a non-limiting embodiment, an output path 318 from the first delay block 314 may be split into at least two paths, with one path a first delay block output path 316 represented by the function letter u, that enables the signal to enter a control feedback loop and return to the first summing node 308. Additionally or alternatively, the output path may travel to block B 320, and the block B 320 may perform an operation on the information entering the block. From there, the signal may leave block B 320 on an output path 322 and enter a second summing node 326.

Returning to the input path 300, this input path enters the observer gain vector block Lₓ 304. The Lₓ 304 gain vector is configured to take a path 300 from the prediction error 276 and output a path 324 to the second summing node 326. In some embodiments, the output path 324 may have an additional path 321 that leads directly to a fourth summing node 360 disposed in the trajectory generator 282. In a non-limiting embodiment, the second summing node 326 receives, as inputs, the path 322 from block B 320 and path 324 from the gain observer Lₓ 304 and outputs a signal path 328 that includes a second delay block 330. In a non-limiting embodiment, an output path 332 leaving the second delay block 330 represented by the function name X(t) may be split into at least two paths, with one path being a path 340 that provides the signal to a control feedback loop and enter block A 344, and then follow a return path 346 to the second summing node 326. Additionally or alternatively, the output path from the second delay block 330 may enter block C 334, and then leave the unmeasured DV model 278 as a signal path represented by an output of a predicted disturbance variable 336 (e.g. DVpred).

Continuing with FIG. 5, the unmeasured DV model block 278 may include a trajectory generator 282, which may include the third summing node 338 and the fourth summing node 360 discussed previously. The third summing node 338 receives the signal path 306 and outputs a signal path 340 that enters a third delay block 342. In a non-limiting embodiment, the third delay block 342 outputs a path 346 that splits into at least two paths: a first path that continues to an additional block B 348, and a control loop feedback path 350 designated by the equation e−Tₛ/τ block 354. The equation block path 352 that exits the equation block 354 may return to the third summing node 338. The first path that enters the additional block B 348 undergoes an operation in the B block 348, and then leaves the B block via a signal path 356.

In a non-limiting embodiment, signal path 356 may enter the fourth summing node 360, along with the path 320 output from the gain observer Lₓ 304. The fourth summing node 360 may output a signal path 358 that enters a fourth delay block 362. In a non-limiting embodiment, the fourth delay block 362 outputs a path 364 that may be split into at least two paths: a first path that continues to an additional block C 370, and a control loop feedback path 368 designated by and additional block A 372, and an equation block e−Tₛ/τ 374. The equation block path 376 that exits the equation block 374 may return to the fourth summing node. The first path that enters the additional block C 370 undergoes an operation in the C block 370, and then leaves the C block 370. This final path is represented by the compensated trajectory 286 and the series of equations 378 illustrated in FIG. 5.

Turning to FIG. 6, an embodiment of a flowchart depicting a process 600 for determining a compensation trajectory for a measured DV is illustrated, according to aspects of the disclosure. In block 610, the DV effect on CV prediction is calculated using a new DV measurement. In block 620, the control model may calculate a change of the prediction by subtracting the previous prediction from the new prediction. In block 630, the resulting difference may be multiplied by the compensating exponentially decaying trajectory. In block 640, the resulting product from block 630 is added to the compensated trajectory from the previous step. In block 650, the resulting sum from block 640 is the new compensated trajectory, and is subsequently utilized as a part of the overall reference trajectory.

Turning to FIG. 7, an embodiment of a flowchart depicting a process 700 for determining a compensation trajectory for an unmeasured DV is illustrated, according to aspects of the disclosure. In block 710, an estimation of the unmeasured DV and its model states are calculated from the prediction error of the process CVs. In block 720, the effect that the unmeasured DV has on the CV is calculated. In block 730, the control model calculates a change of the prediction by subtracting the previous prediction from the new one. In block 740, the resulting difference from block 730 is multiplied by the compensating exponentially decaying trajectory. In block 750, the product from block 740 is added to the decaying trajectory. In block 760, the resulting sum from block 750 may be utilized as a part of the overall reference trajectory.

FIGS. 8-11 illustrate graphical results after implementation of various embodiments from aspects of the present disclosure. In FIG. 8, a comparison between a system response utilizing a classic MPC style control system and an embodiment of the present disclosure is displayed. The overall system response is a part of a self-regulating process with no model error. As shown, the graphs in the top row illustrate the system responses while utilizing aspects from the present disclosure (i.e. Proposed version) and the graphs in the bottom row illustrate the system responses while utilizing traditional methods for system control (i.e. Classic MPC). Particularly, the top right graph and the bottom right graph illustrate the system response characteristics on the process outputs (CVs), and highlights the resulting differences between the two approaches in response to changes in a measured DV, a setpoint change, and an unmeasured load distribution change. Comparing the system responses, the top right graph appears to illustrate a smoother, more robust response to these changing variables.

In FIG. 9, a comparison between a system response utilizing a classic MPC style control system and an embodiment of the present disclosure is displayed. The overall system response is a part of a self-regulating process with model gain and dead time error. As shown, the graphs in the top row illustrate the system responses while utilizing aspects from the present disclosure (i.e. Proposed version) and the graphs in the bottom row illustrate the system responses while utilizing traditional methods for system control (i.e. Classic MPC). Particularly, the top right graph and the bottom right graph illustrate the system response characteristics on the process outputs (CVs), and highlights the resulting differences between the two approaches in response to changes in a measured DV, a setpoint change, and an unmeasured load distribution change. Comparing the system responses, the top right graph appears to illustrate a smoother, more robust response to these changing variables.

In FIG. 10, a comparison between a system response utilizing a classic MPC style control system and an embodiment of the present disclosure is displayed. The overall system response is a part of an integrating process with no model error. As shown, the graphs in the top row illustrate the system responses while utilizing aspects from the present disclosure (i.e. Proposed version) and the graphs in the bottom row illustrate the system responses while utilizing traditional methods for system control (i.e. Classic MPC). Particularly, the top right graph and the bottom right graph illustrate the system response characteristics on the process outputs (CVs), and highlights the resulting differences between the two approaches in response to changes in a measured DV, a setpoint change, and an unmeasured load distribution change. Comparing the system responses, the top right graph appears to illustrate a smoother, more robust response to these changing variables.

In FIG. 11, a comparison between a system response utilizing a classic MPC style control system and an embodiment of the present disclosure is displayed. The overall system response is a part of an integrating process with model gain and dead time error. As shown, the graphs in the top row illustrate the system responses while utilizing aspects from the present disclosure (i.e. Proposed version) and the graphs in the bottom row illustrate the system responses while utilizing traditional methods for system control (i.e. Classic MPC). Particularly, the top right graph and the bottom right graph illustrate the system response characteristics on the process outputs (CVs), and highlights the resulting differences between the two approaches in response to changes in a measured DV, a setpoint change, and an unmeasured load distribution change. Comparing the system responses, the top right graph appears to illustrate a smoother, more robust response to these changing variables.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is intended to cover all modifications, equivalents, and alternatives falling within the spirit and scope of the present disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A non-transitory computer readable medium storing instructions that, when executed by processing circuitry, cause the processing circuitry to perform operations comprising:
determining a predicted value for a process output representative of controlled operation of one or more industrial automation devices within an industrial automation system;
receiving an actual value for the process output from the industrial automation devices;
determining a deviation between the predicted value and the actual value for the process output;
generating a first portion of a reference trajectory based on a closed-loop response performance to a change in a setpoint;
generating a second portion of the reference trajectory based on a calculated effect from a measured disturbance variable on the actual value for the process output;
generating a third portion of the reference trajectory based on an estimation of an unmeasured disturbance variable, wherein the unmeasured disturbance variable is based on the determined deviation between the predicted value and the actual value for the process output;
summing the first portion, second portion, and third portion of the reference trajectory; and
outputting the reference trajectory to the industrial automation system.

2. The non-transitory computer readable medium of claim 1, wherein generating the first portion of the reference trajectory comprises applying a setpoint filter configured to tune the process outputs to correspond to the setpoint.

3. The non-transitory computer readable medium of claim 2, wherein the setpoint filter is a first order filter.

4. The non-transitory computer readable medium of claim 1, wherein generating the second portion of the reference trajectory comprises applying a measured disturbance variable (DV) model configured to output a measured DV compensated trajectory.

5. The non-transitory computer readable medium of claim 4, wherein the measured DV model comprises a finite step response model.

6. The non-transitory computer readable medium of claim 1, wherein generating the third portion of the reference trajectory comprises applying an unmeasured disturbance variable (DV) model configured to output an unmeasured DV compensated trajectory.

7. The non-transitory computer readable medium of claim 6, wherein the unmeasured DV model comprises a linear state space model with unknown inputs.

8. A system, comprising:
processing circuitry; and
a memory, accessible by the processing circuitry, and storing instructions that, when executed by the processing circuitry, cause the processing circuitry to perform actions comprising:
determining a predicted value for a process output representative of controlled operation of one or more industrial automation devices within an industrial automation system;
receiving an actual value of the process output from the industrial automation devices;
determining a deviation between the predicted value and the actual value for the process output; and
generating a portion of a reference trajectory based on an estimation of an unmeasured disturbance variable, wherein the unmeasured disturbance variable is based on the determined deviation between the predicted value and the actual value for the process output.

9. The system of claim 8, wherein generating the portion of the reference trajectory comprises applying an unmeasured disturbance variable (DV) model configured to output an unmeasured DV compensated trajectory.

10. The system of claim 9, wherein the unmeasured DV model comprises a state estimation block.

11. The system of claim 10, wherein the state estimation block is configured to:
receive an input indicative of the determined deviation between the predicted value and the actual value for the process output; and
output an estimation for a value for the determined deviation that is attributable to the unmeasured disturbance variable.

12. The system of claim 10, wherein the state estimation block comprises at least one observer gain vector.

13. The system of claim 11, wherein the state estimation block comprises at least one delay block configured to account for a dead time between a change in a system input and a system response.

14. The system of claim 10, wherein the unmeasured DV model comprises a trajectory generator.

15. The system of claim 14, wherein the trajectory generator is configured to:
receive the output from the state estimation block; and
output a compensated trajectory.

16. The system of claim 14, wherein the trajectory generator comprises at least one delay block configured to account for a dead time between a change in a system input and a system response.

17. The system of claim 14, wherein the trajectory generator comprises at least one summing node configured to receive input signal paths and transmit output signal paths.

18. A method, comprising:
determining a predicted value for a process output representative of controlled operation of one or more industrial automation devices within an industrial automation system;
receiving an actual value for the process output from the industrial automation devices;
generating a first portion of a reference trajectory based on a closed-loop response performance to a change in a setpoint;
generating a second portion of the reference trajectory based on a calculated effect from a measured disturbance variable on the actual value for the process output;
generating a third portion of the reference trajectory based on an estimation of an unmeasured disturbance variable;
summing the first portion, second portion, and third portion of the reference trajectory; and
outputting the reference trajectory to the industrial automation system.

19. The method of claim 18, wherein generating the second portion of the reference trajectory comprises:
calculating an effect that the measured disturbance variable has on the predicted value for the process output;
subtracting the predicted value for the process output from a new predicted value to obtain a difference;
multiplying the difference by a decaying trajectory to obtain a product;
summing the product with a compensated trajectory to obtain a sum; and
utilizing the sum as an updated compensated trajectory as a part of the reference trajectory.

20. The method of claim 18, wherein third portion of the reference trajectory comprises:
estimating a value of the unmeasured disturbance variable based on a determined difference between the received actual value for the process output and the predicted value for the process output;
calculating an effect that the unmeasured disturbance variable had on the process output;
subtracting the predicted value for the process output from a new predicted value to obtain a difference;
multiplying the difference by a decaying trajectory to obtain a product;
summing the product with a compensated trajectory to obtain a sum; and
utilizing the sum as an updated compensated trajectory as a part of the reference trajectory.
